(19) United States
(12) Patent Application Publication
(10) Pub. No.: US 2022/0009463 A1
(43) Pub. Date: Jan. 13, 2022

(54) ELECTRIC BRAKE

(71) Applicant: Hitachi Astemo, Ltd., Hitachinaka-shi, Ibaraki (JP)

(72) Inventors: Yasushi KINOSHITA, Tokyo (JP); Kengo SUZUKI, Hitachinaka-shi, Ibaraki (JP); Atsushi ODAIRA, Hitachinaka-shi, Ibaraki (JP); Haruhiko FUJITA, Hitachinaka-shi, Ibaraki (JP)

(73) Assignee: Hitachi Astemo, Ltd., Hitachinaka-shi, Ibaraki (JP)

(21) Appl. No.: 17/295,171

(22) PCT Filed: Aug. 22, 2019
(86) PCT No.: PCT/JP2019/032775

§ 371 Date: May 19, 2021

(30) Foreign Application Priority Data
Nov. 29, 2018 (JP) 2018-223382

(51) Int. Cl. B60T 13/74; B60T 17/22; F16D 55/226; F16D 66/00; F16H 25/22

(52) U.S. Cl. CPC B60T 13/741; B60T 17/22; F16D 55/226; F16D 2125/36; F16H 25/22; F16D 2066/005; F16D 66/00

(57) ABSTRACT

An object of the present invention is to provide an electric brake with excellent operability, in which a compact brake thrust detection sensor is installed. To achieve the object, the electric brake of the present invention includes a rotary shaft rotated by the rotational force, a piston axially moved by a translational force converted from rotation of the rotary shaft, a brake pad pressed against a disc in accompany with a translational motion of the piston, a thrust bearing which receives a thrust load applied to the rotary shaft, and a support member which axially supports the thrust bearing. The thrust bearing includes a first bearing washer which is in contact with the rotary shaft to receive the thrust load, and rotates integrally with the rotary shaft, a second bearing washer fixed to the support member, and multiple rolling elements held between the first bearing washer and the second bearing washer. The second bearing washer has its surface in contact with the support member provided with a supported portion that is in contact with the support member, and a non-supported portion that is not in contact with the support member. A strain sensor is disposed on the non-supported portion.

### TECHNICAL FIELD

The present invention relates to an electric brake device provided with a brake thrust detection sensor.

### BACKGROUND ART

Generally, an electric brake is configured to have a screw feeding mechanism for converting the rotational force into the translational force (brake thrust), a piston, a brake pad, and a disc, which are arranged in series in an axial direction. The screw feeding mechanism is used for adjusting the distance between the disc and the brake pad to execute brake on/off control operations. The electric brake is required to secure sufficient stroke for the brake pad in order to prevent the contact between the brake pad and the disc, and the resultant wear in a brake-off state. Accordingly, the electric brake is likely to have an axially long structure. Assembly of the above-structured electric brake with the vehicle for storage inside the tire wheel may impose severe restriction on the external dimension in the axial direction.

The electric brake disclosed in Patent Literature 1 has been known as having the brake thrust detection sensor for improving brake operability. The specification in paragraphs 0024 and 0025 as disclosed in the document describes that “The electric disc brake device according to the invention is provided with the thrust bearing for supporting axial loads applied to the input member from the output member via the planetary roller when applying the braking force to the disc rotor. The load sensor is disposed at the back of the thrust bearing to allow detection of the magnitude of the braking force applied to the disc rotor.” and “It is possible to employ the magnetostriction sensor, the strain detection type load sensor, and the magnetic load sensor as the above-described load sensor.” FIGS. 1, 2 and the like disclose that the load sensor 29 is held between the thrust bearing 28 and the shaft support member 8.

That is, Patent Literature 1 discloses the brake device provided with the load sensor that is held and compressed between the thrust bearing 28 and the shaft support member 8 so that the magnitude of the braking force can be detected.

### CITATION LIST

### Patent Literature

Patent Literature 1: Japanese Unexamined Patent Publication No. 2014-7845

### SUMMARY OF INVENTION

### Technical Problem

The electric brake as disclosed in Patent Literature 1 employs the relatively large-sized load sensor such as the magnetostriction sensor, the strain detection type load sensor, and the magnetic load sensor. The height dimension of the load sensor in addition to the axial dimension makes the overall size of the electric brake longer in the axial direction. It is therefore difficult for the electric brake as disclosed in Patent Literature 1 to provide the compact electric brake for use in vehicle, which matches the external dimension restriction.

It is an object of the present invention to make the brake thrust detection sensor compact to allow usage of the electric brake for vehicle, and to provide the electric brake having axial dimension unaffected by the height dimension of the detection sensor.

### Solution to Problem

To solve the above-described problem, the present invention provides an electric brake which includes an electric motor for generating a rotational force, a rotary shaft which is rotated by the rotational force generated by the electric motor, a piston which is axially moved by a translational force converted from rotation of the rotary shaft, a brake pad which is pressed against a disc in accompany with a translational motion of the piston, a thrust bearing which receives a thrust load applied to the rotary shaft, and a support member which supports the thrust bearing in an axial direction. The thrust bearing includes a first bearing washer which is in contact with the rotary shaft to receive the thrust load, and rotates integrally with the rotary shaft, a second bearing washer which is fixed to the support member, and multiple rolling elements which are held between the first bearing washer and the second bearing washer. The second bearing washer has its surface in contact with the support member provided with a supported portion that is in contact with the support member, and a non-supported portion that is not in contact with the support member. A strain sensor is disposed on the non-supported portion.

### Advantageous Effects of Invention

The present invention ensures to make the electric brake having the brake thrust detection sensor compact.

The problems, structures, and effects other than those described above will be clarified by explanations of the embodiments as described below.

### BRIEF DESCRIPTION OF DRAWINGS

FIG. 1 is a sectional view of a structure of an electric brake according to a first embodiment.

FIG. 2 is a perspective sectional view of a peripheral structure of a thrust bearing of the electric brake according to the first embodiment.

FIG. 3 is a sectional view taken along line A-A of FIG. 2, indicating balance of force.

FIG. 4 illustrates two notches formed in a housing of the electric brake according to the first embodiment.

FIG. 5 is a load-strain characteristic view representing signals from left and right strain sensors as illustrated in FIG. 4, and an average signal value of those from the respective strain sensors.

FIG. 6 is a perspective sectional view of a peripheral structure of a thrust bearing 9 of the electric brake according to a second embodiment.

FIG. 7 is a perspective sectional view illustrating a structure having a base on an installation section of the strain sensor as illustrated in FIG. 6.

### DESCRIPTION OF EMBODIMENTS

Embodiments will be described with reference to the drawings.

### First Embodiment

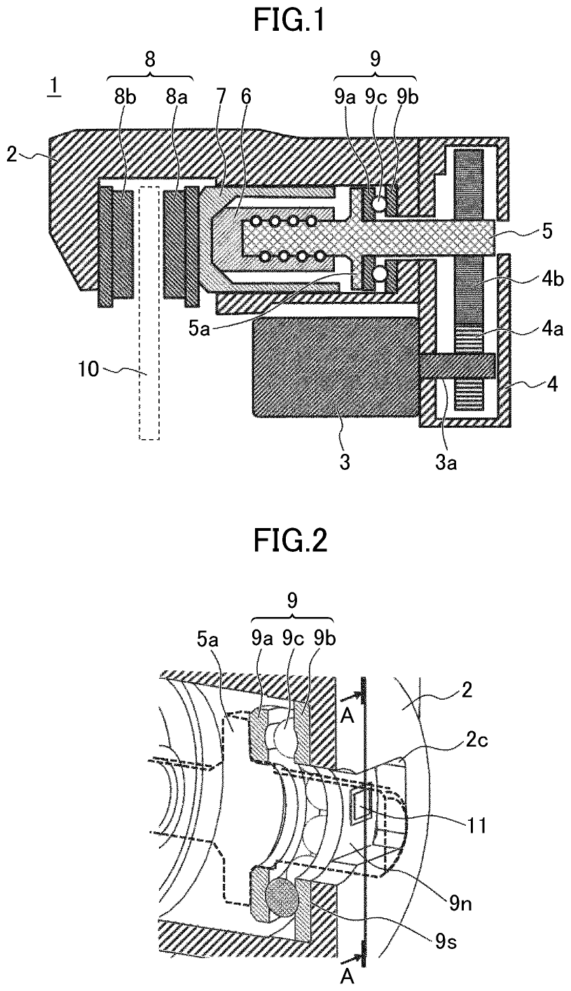

An electric brake 1 according to a first embodiment of the present invention will be described referring to FIGS. 1 to 5.

FIG. 1 is a sectional view of a structure of the electric brake 1, illustrating a housing 2, an electric motor 3, a decelerator 4, a rotary shaft 5, a nut 6, a piston 7, a brake pad 8, a thrust bearing 9, and a disc 10. The electric brake 1 including those components is configured to press the brake pad 8 against the disc 10 using the electric motor 3 as the driving source so that the braking force is applied to the disc 10 by friction.

The electric motor 3 which generates the rotational force is an electric drive motor such as a brushless motor, a DC motor, and a direct motor, and configured to control rotation of a motor shaft 3a in accordance with current signals and voltage signals from the external controller.

The decelerator 4 is formed by combining a gear 4a fitted with the motor shaft 3a, and a gear 4b fitted with the rotary shaft 5, and configured to decelerate the rotational speed of the motor shaft 3a to transmit large rotational force to the rotary shaft 5. FIG. 1 illustrates the simply structured decelerator 4 composed of two gears. It is possible to use the planetary gear and multistage gear to secure higher reduction ratio. The electric motor 3 formed as the direct motor may be directly connected to the rotary shaft 5 by omitting the decelerator 4.

The rotary shaft 5 with a flange 5a disposed in the substantially center has a spiral groove formed in an outer surface at a side closer to the brake pad 8 than the flange 5a. The thrust bearing 9 allows the rotary shaft 5 to freely rotate around the axis while restraining the axial translational motion. The nut 6 has a spiral groove formed in the inner surface opposite to the groove of the rotary shaft 5. A not-shown rotation regulating guide serves to restrain the nut 6 from rotating. Combination of the rotary shaft 5 with the nut 6 constitutes the screw feeding mechanism such as a ball screw having multiple balls intervened between spiral grooves formed in the rotary shaft 5 and the nut 6. The screw feeding mechanism converts the rotational force of the rotary shaft 5 into the axial translational force of the nut 6.

The piston 7 is connected to the nut 6, and axially moved upon reception of the translational force of the nut 6. The brake pads 8 are provided at both sides of the disc 10 to be held therebetween. In the drawing, a brake pad 8a at the right side is connected to the piston 7, and pressed against the disc 10 as the piston 7 translationally moves. A brake pad 8b at the left side is attached to the housing 2. When the brake pad 8a is pressed against the disc 10, the housing 2 moves toward the decelerator 4 in reaction to pressing of the brake pad 8a against the disc 10 so that the brake pad 8b is pressed against the disc 10. The disc 10 is a circular plate-like member which is operated inter-connectedly with wheels of the vehicle. Upon reception of frictional resistance (braking force) resulting from the force (brake thrust) held by both the brake pads 8, the rotational speed is decelerated.

The peripheral structure of the thrust bearing 9 according to the embodiment will be described in detail.

FIG. 2 is a perspective sectional view of a peripheral structure of the thrust bearing 9 of the electric brake 1. As the drawing illustrates, the housing 2 of the electric brake 1 is a support member for supporting the thrust bearing 9 in the axial direction. The housing 2 has a notch 2c in a part of the surface that comes in contact with the thrust bearing 9. One surface of a bearing washer 9b is distinguished between a supported portion 9s and a non-supported portion 9n depending on the contact with the housing 2. FIG. 2 indicates the rotary shaft 5 by a dotted line so that the notch 2c can be seen through.

The thrust bearing 9 includes a pair of bearing washers 9a, 9b, and multiple rolling elements 9c which are held between the bearing washers. As FIG. 2 illustrates, a strain sensor 11 is disposed on the non-supported portion 9n of the bearing washer 9b.

A track for guiding the rolling elements 9c to orbit is formed on one surface of the bearing washer 9a at the side of the piston 7. The other surface of the bearing washer 9a is allowed to rotate integrally with the rotary shaft 5 while being in abutment on the flange 5a of the rotary shaft 5. A track for guiding the rolling elements 9c to orbit is formed on one surface of the bearing washer 9b at the side of the decelerator 4. The other surface of the bearing washer 9b is abutted on the housing 2 for support and fixation. The multiple rolling elements 9c are held between the bearing washers 9a and 9b, and orbit along the tracks each formed on the bearing washers 9a, 9b, respectively. The rolling element 9c may be spherically shaped or cylindrically shaped. Normally, a not shown holder is provided for keeping the uniform pitch between the rolling elements 9c, and preventing the rolling element 9c from falling out from the track.

The housing 2 has the notch 2c formed in a part of the surface in contact with the bearing washer 9b. The housing 2 may be structured to have a support member independent from the housing 2, for example, a washer for supportively fixing the bearing washer 9b. In this case, the notch 2c is formed in the independent support member. The notch 2c defines the supported portion 9s which is in contact with the housing 2 for receiving the load and the non-supported portion 9n which is not in contact with the housing 2 on the contact surface of the bearing washer 9b. The supported portion 9s and the non-supported portion 9n are formed alongside in a circumferential direction around the rotary shaft 5. The non-supported portion 9n is formed as a circumferential beam structure while having both sides supported with the supported portions 9n, and is likely to generate strain in the circumferential direction.

The strain sensor 11 is installed on the non-supported portion 9n for detecting the strain which occurs in the non-supported portion 9n. It is preferable to install the strain sensor 11 on the center of the non-supported portion 9n. In the beam structure, the bending moment M becomes maximum at the center of the beam, at which the strain becomes large. As a result, improvement in the S/N ratio is expected. The strain sensor 11 may be a strain IC having a piezo-resistance positioned at the center of the upper surface of the silicon chip, and a Wheatstone bridge, an amplifier circuit, a temperature guarantee circuit, or the like produced in the semiconductor process, which is positioned around the piezo-resistance. Using the piezo-resistance effect, the strain exerted to the strain sensor 11 is taken as the resistance change. The strain sensor 11 may be in the form of the strain gauge or the like.

An explanation will be made with respect to a brake thrust detection method for the electric brake 1 according to the embodiment.

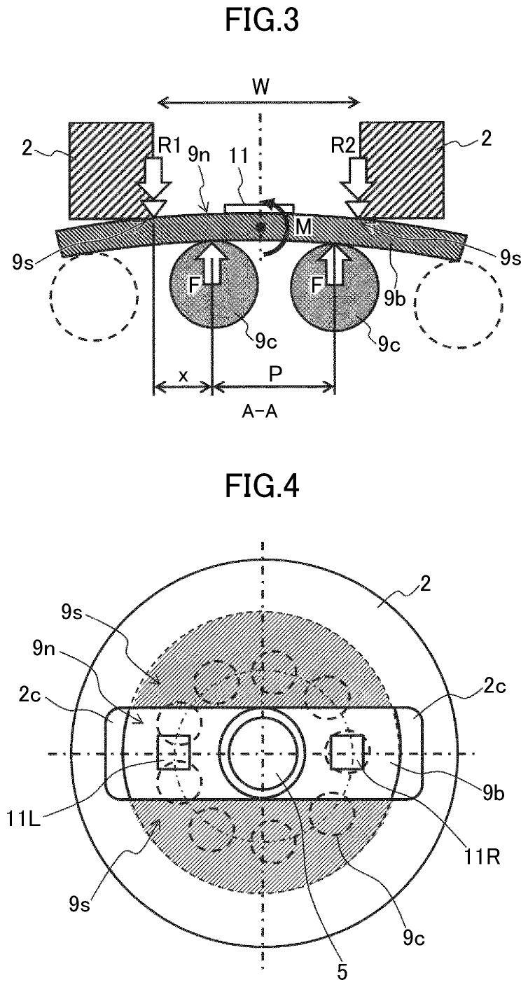

FIG. 3 is a sectional view taken along line A-A of FIG. 2, indicating balance of force. Referring to FIG. 3, “F” denotes the load applied by the rolling element 9c, each of “R1” and “R2” denotes the counterforce at the respective supported portions, “M” denotes the bending moment, “W” denotes a width of the notch 2c, “P” denotes a pitch between the rolling elements 9c, and “x” denotes a distance between the support point and the center of the rolling element 9c.

Assuming that the two rolling elements 9c exist inside the width W of the notch 2c as illustrated in FIG. 3, the strain ϵ is calculated using formulae 1 to 5 in reference to balance of force.

[Formula 1]

R1+R2=2 F Formula 1

[Formula 2]

W·R2=F·x+F·(x+P) Formula 2

[Formula 3]

M=W·R1/2−(W/2−x)·F Formula 3

The formula 1 is an equation to calculate the balance of force, the formula 2 is an equation to calculate the balance of moment of force, and the formula 3 is an equation to calculate the bending moment at midpoint of the notch width W.

[Formula 4]

M=(W−P)·F/2 Formula 4

The formula 4 is an equation to calculate the bending moment at midpoint of the notch width W as a result of developing the formulae 1 to 3.

[Formula 5]

ϵ=σ/E=M/EZ=6·M/E·b·h² Formula 5

The formula 5 is an equation to calculate the strain ϵ of the bearing washer 9b, which occurs at midpoint of the notch width W. The “σ” denotes stress, “E” denotes Young's modulus, “Z” denotes section modulus, “b” denotes a width, and “h” denotes a thickness.

The counterforce of the brake thrust during braking operation is transmitted to the bearing washer 9b via the bearing washer 9a and the rolling elements 9c inside the thrust bearing 9. Referring to FIG. 3, each of the circular shaped rolling elements 9c applies the load F to the bearing washer 9b from below. In the state where the notch 2c is formed in the housing 2, the bearing washer 9b under the load F has the supported portion 9s to be made contact and supported with the housing 2. The load F applied from the rolling elements 9c, and the counterforces R1, R2 which act on the supported portion 9s cause the non-supported portion 9n of the bearing washer 9b to undergo three-point bending or four-point bending, resulting in flexure of the non-supported portion 9n. The strain caused by the flexure is detected by the strain sensor 11 so that the brake thrust is estimated.

In the case of the beam structure of the non-supported portion 9n, as the rotary shaft 5 is rotated to change the brake thrust, the rolling element 9c orbits to change its position. The position of the load F, thus is shifted. The shifting of the load F changes distribution of the strain which occurs in the non-supported portion 9n. As a result, outputs of the strain sensor 11 fluctuate as the rolling element 9c orbits. The fluctuation will occur every passage of the rolling elements 9c below the non-supported portion 9n, which can be observed as periodic variations.

An explanation will be made with respect to the relation between the number of the rolling elements 9c and fluctuation of the strain which occurs in the position where the strain sensor 11 is disposed on the assumption that the center of the notch width W is set as the position of the strain sensor 11. If the one rolling element 9c passes through the section of the notch width W, substantially no strain occurs when the load F exists around the support point, and the strain becomes maximum when the load exists just below the strain sensor 11, resulting in large periodic variation. If the two rolling elements 9c pass through the section of the notch width W, the strain occurs as one of the loads F exists just below the strain sensor 11 even if the other load exists around the support point. When the load F exists midway between the support point and the strain sensor 11, each strain caused by the two loads F overlaps with each other so that the periodic variation of the strain can be kept small. As the formula 4 indicates, the bending moment M which occurs in the center of the notch width W is expressed by the formula of M=(W−P)F/2 using the notch width W, the pitch P between the rolling elements, and the load F without depending on the position x of the rolling element. If the three rolling elements 9c pass through the section of the notch width W, two different states occur between the support point and the stress sensor 11, that is, the state having one force point and the state having two force points. This may cause bias in the load F between the left and right strain sensors 11, resulting in fluctuation in the strain.

As described above, the notch width W and the pitch P between the rolling elements 9c are set to establish the relation of substantially W=2P so that the two rolling elements 9c always pass through the section of the notch width W. If the width W of the notch 2c is made smaller than twice the pitch P between the rolling elements, the period for which only one rolling element 9c exists in the notch width W during orbiting is prolonged. This makes the periodic variations larger. If the width W of the notch 2c is made larger than twice the pitch P between the rolling elements, the period for which the three rolling elements 9c exist in the width W of the notch 2c during orbiting is prolonged. This makes the periodic variations larger. The notch width W and the pitch P between the rolling elements are set to establish the relation of substantially W=2P to keep the period for which the two rolling elements 9c pass through the notch width W during orbiting. This makes it possible to suppress occurrence of the periodic variations.

When setting the relation between the width W of the notch 2c and the pitch P between the rolling elements 9c to W=2P, the strain which occurs in the center of the notch width W is proportional to the bending moment M as represented by the formula 5, and is inversely proportional to the Young's modulus E and the section modulus Z of the bearing washer 9b. That is, as the bending moment M fluctuates less, the fluctuation of the strain ϵ reduced.

### Modified Example of First Embodiment

FIG. 4 illustrates two notches 2c formed in the housing 2 of the electric brake 1, and the strain sensors are disposed in the notches, respectively. FIG. 4 illustrate a left strain sensor 11L, and a right strain sensor 11R. FIG. 5 is a load-strain characteristic view representing output signals of the strain sensors 11L, 11R, and an average value 11AVG of those output signals.

As the example of FIG. 4 illustrates, the multiple notches 2c may be formed in the housing 2. The notches 2c allow multiple non-supported portions 9n to be formed on the bearing washer 9b, each of which causes the strain owing to the beam structure. The multiple strain sensors 11 are provided for detecting the respective strains. In spite of failure in one of the strain sensors 11, the above-described structure can execute fail-safe operations for maintaining the control using outputs of the other strain sensor 11. The average value 11AVG of outputs from the multiple strain sensors 11 is calculated for controlling operations. This makes it possible to smooth the periodic variations, and improve noise resistance.

Referring to the example of FIG. 4, the notches 2c are formed at the horizontally symmetrical (or point symmetrical) positions with respect to the section of FIG. 1. Upon reception of the brake thrust, the housing 2 is deformed to slightly widen its arm portion formed to enclose the disc 10, and then warped in the up-down direction. The deformation biases the load applied to the thrust bearing 9 in the up-down direction. As the strain sensors 11 are arranged horizontally symmetrically with respect to the cross section of FIG. 1, difference between the sensors owing to the biased load hardly occurs. This makes it possible to match the respective characteristics. Although one of the sensors is broken, the control can be continuously executed without significantly changing the control characteristics.

In the case where the notches 2c are formed at positions where the circumference around the rotary shaft 5 as the center is divided into two equal sections, the number of the rolling elements 9c is set to an odd number. When the rolling element 9c passes below one of the strain sensors 11, the midpoint between the rolling elements 9c is positioned below the other strain sensor 11. When the rolling element 9c passes just below the strain sensor 11, the value of the detected strain becomes maximum. When the rolling element 9c is at the furthest position from the strain sensor 11, the value of the detected strain becomes minimum. Those values are observed as periodic variations. The phases of the left and the right strain sensors 11L, 11R are shifted to be made different from each other by 180° to calculate the average value 11AVG. As a result, the periodic variation may be offset by each other as represented by FIG. 5.

The electric brake 1 of the embodiment includes the electric motor 3, the rotary shaft 5 having a thread groove, which is rotated by the rotational force of the electric motor 3, the nut 6 which is screwed with the thread groove of the rotary shaft 5, and axially movable, the brake pad 8 thrusted by the nut 6, the thrust bearing 9 which receives the thrust load applied to the rotary shaft 5, and the housing 2 which supports the thrust bearing 9 to store a part of the component. The thrust bearing 9 includes the bearing washer 9a that comes in contact with the rotary shaft 5 for receiving the thrust load, the bearing washer 9b that comes in contact with the housing 2 to receive the thrust load, and the multiple rolling elements 9c held between the bearing washers 9a and 9b. The supported portion 9c of the bearing washer 9b, which is in contact with the housing 2 has the non-supported portion 9n formed as its part, on which the strain sensor 11 is disposed. The non-supported portion 9n of the bearing washer 9b is defined by the notch 2c formed in the support member 2. The multiple notches 2c are formed horizontally symmetrically on the circumference around the axis at an equal interval. The width W of the notch 2c is twice the pitch P between the rolling elements 9c. The strain sensor 11 is disposed on the center of the width W of the notch 2c. The odd numbered rolling elements 9c are arranged so that each phase of timing at which the rolling elements 9c pass below the left and the right strain sensors is made different by 180°.

The electric brake may be made further compact by integrating the load sensors with the thrust bearing, which are axially arranged. It is possible to provide the electric brake with excellent operability as a result of executing the feedback control by detecting the brake thrust.

### Second Embodiment

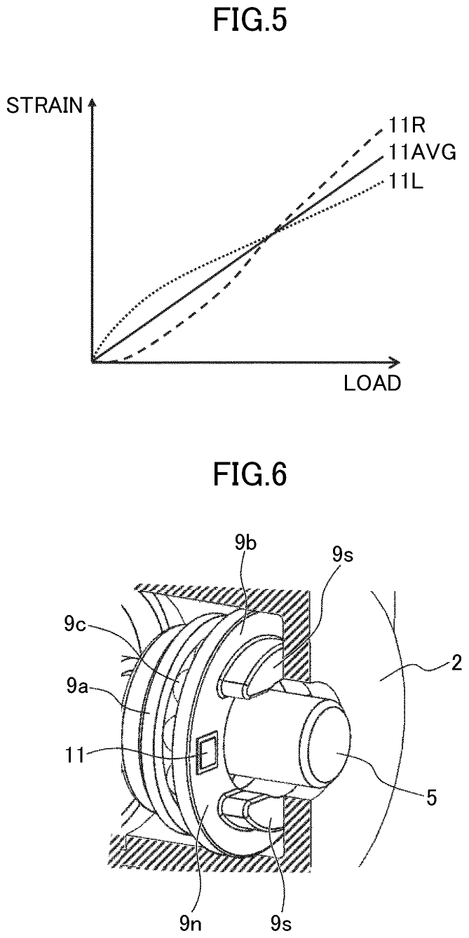

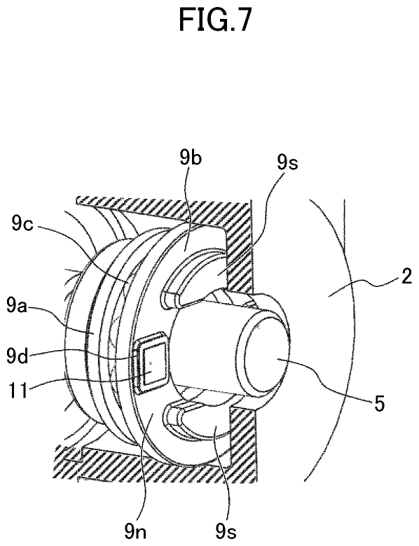

An electric brake according to a second embodiment of the present invention will be described referring to FIGS. 6 and 7. Explanations common to those described in the first embodiment will be omitted.

FIG. 6 is a perspective sectional view of a peripheral structure of the thrust bearing 9 of the electric brake 1 according to the second embodiment. In the first embodiment, the notches 2 are formed in the housing 2 to define the non-supported portion 9n on the outer surface of the bearing washer 9b, which does not come in contact with the housing 2. In the second embodiment, instead of forming the notches 2c, a part of the contact surface of the bearing washer 9b is made one-step lower so that the lowered part is formed as the non-supported portion 9n.

The two supported portions 9s of the bearing washer 9b as illustrated in FIG. 6 are kept and arranged in the up-down direction, and the rest of the part is formed one-step lower. The one-step lower part that is apart from the housing 2 serves as the non-supported portion 9n. The non-supported portion 9n between the two supported portions 9s has the beam structure that receives the load F from the rolling element 9c orbiting below the non-supported portion 9n while having each of the supported portions 9s taken as the support point. The strain sensor 11 is disposed on the center of the non-supported portion 9n held between the two supported portions 9s.

Like the first embodiment, the non-supported portion 9n of the bearing washer 9b is formed so that the strain that occurs in the non-supported portion 9n is detected. This makes it possible to detect the brake thrust. Compared with the first embodiment, this embodiment allows the housing 2 to keep high rigidity, and contributes to reduction in the cost for machining the housing 2.

FIG. 7 is a perspective sectional view of a structure having a base 9d on an installation section of the strain sensor 11 as illustrated in FIG. 6. The base 9d disposed on the bearing washer 9b, on which the strain sensor 11 is installed forms the beam structure constituted by the non-supported portion 9n to have the cross section of the center part with large thickness. The strain that occurs in the surface of the beam fluctuates less around the center of the non-supported portion 9n to become substantially uniform. The structure allows reduction in the periodic variation caused by orbiting of the rolling element 9c.

Like the first embodiment, the above-described structure ensures to make the electric brake compact by integrating the axially arranged load sensors with the thrust bearing of the electric brake 1. The embodiment further provides the electric brake with excellent operability as a result of executing the feedback control by detecting the brake thrust.

### LIST OF REFERENCE SIGNS

1 . . . electric brake,

2 . . . housing,

2c . . . notch,

3 . . . electric motor,

3a . . . motor shaft,

4 . . . decelerator,

4a, 4b . . . gear,

5 . . . rotary shaft,

5a . . . flange,

6 . . . nut,

7 . . . piston,

8, 8a, 8b . . . brake pad,

9 . . . thrust bearing,

9a, 9b . . . bearing washer,

9c . . . rolling element,

9d . . . base,

9s . . . supported portion,

9n . . . non-supported portion,

10 . . . disc,

11, 11L, 11R . . . strain sensor

1. An electric brake, comprising:
an electric motor for generating a rotational force;
a rotary shaft which is rotated by the rotational force generated by the electric motor;
a piston which is axially moved by a translational force converted from rotation of the rotary shaft;
a brake pad which is pressed against a disc in accompany with a translational motion of the piston;
a thrust bearing which receives a thrust load applied to the rotary shaft; and
a support member which supports the thrust bearing in an axial direction, wherein:
the thrust bearing includes a first bearing washer which is in contact with the rotary shaft to receive the thrust load, and rotates integrally with the rotary shaft, a second bearing washer which is fixed to the support member, and multiple rolling elements which are held between the first bearing washer and the second bearing washer;
the second bearing washer has its surface in contact with the support member provided with a supported portion that is in contact with the support member, and a non-supported portion that is not in contact with the support member; and
a strain sensor is disposed on the non-supported portion.

2. The electric brake according to claim 1, wherein:
a screw feeding mechanism includes a spiral groove formed in an outer surface of the rotary shaft, a spiral groove formed in an inner surface of a nut connected to the piston, and multiple balls intervening between both the grooves; and
the screw feeding mechanism converts the rotation of the rotary shaft into the translational force.

3. The electric brake according to claim 1, wherein the support member is a housing of the electric brake, or a washer disposed between the thrust bearing and the housing.

4. The electric brake according to claim 1, wherein the strain sensor is disposed on a substantially center of the non-supported portion.

5. The electric brake according to claim 4, wherein a width W of the non-supported portion in a circumferential direction is substantially twice a pitch P between the rolling elements in an orbiting direction.

6. The electric brake according to claim 1, wherein the second bearing washer includes multiple non-supported portions.

7. The electric brake according to claim 6, wherein the multiple non-supported portions are disposed linearly symmetrically with the second bearing washer.

8. The electric brake according to claim 7, wherein when the two strain sensors are disposed point symmetrically with the second bearing washer, a phase of timing at which the rolling element passes below one of the strain sensors is made different from a phase of timing at which the rolling element passes below the other strain sensor by 180°.

9. The electric brake according to claim 6, wherein the multiple non-supported portions are circumferentially arranged each at an equal interval.

10. The electric brake according to claim 6, wherein a control operation is executed using an average value of signal outputs from the multiple strain sensors which are respectively disposed on the non-supported portions.

11. The electric brake according to claim 1, wherein a notch formed in the support member allows the non-supported portion to be formed on the second bearing washer at a side in contact with the support member.

12. The electric brake according to claim 1, wherein the non-supported portion is formed by making a part of a surface of the second bearing washer, which is in contact with the support member lower in height to be separated away from the support member.

13. The electric brake according to claim 12, wherein a base is formed on the non-supported portion, and the strain sensor is disposed on the base.
